(19) United States
(12) Patent Application Publication
(10) Pub. No.: US 2020/0055068 A1
(43) Pub. Date: Feb. 20, 2020

(54) HOSE ADAPTER FOR A PAINT SPRAYER

(71) Applicant: TECHTRONIC CORDLESS GP, Anderson, SC (US)

(72) Inventors: Tyler Knight, Greenville, SC (US); Peter J. Roberts, Greenville, SC (US); Daniel I. Smith, Greenville, SC (US)

(21) Appl. No.: 16/542,391

(22) Filed: Aug. 16, 2019

Related U.S. Application Data
(60) Provisional application No. 62/764,927, filed on Aug. 16, 2018.

(51) Int. Cl. B05B 11/00; B05B 15/55; B08B 9/00

(52) U.S. Cl. CPC B05B 11/0008; B08B 9/00; B05B 15/55

(57) ABSTRACT

An adapter connectable to a paint sprayer includes a body, a first connector, and a second connector. The first connector is positioned on a first end of the body. The first connector is removably connectable to the paint sprayer. The second connector is positioned on a second end of the body. The second end is opposite the first end. The second connector is configured for connecting to a fluid source.

### CROSS REFERENCE TO RELATED APPLICATIONS

The present patent application claims priority to U.S. Provisional Patent Application No. 62/764,927 titled “HOSE ADAPTER FOR A PAINT SPRAYER” and filed on Aug. 16, 2018, the entire contents of which is hereby incorporated by reference.

### BACKGROUND

The present invention relates to adapters for paint sprayers, and more particularly to a hose adapter for a paint sprayer.

Paint sprayers include a pump driven by an electric motor for pressurizing paint for subsequent discharge through a spray gun. An adapter may be used to vary what other devices the paint sprayer is connected thereto.

### SUMMARY

The present embodiment provides, in one aspect, an adapter that may be connectable to a paint sprayer. The adapter may include a body, a first connector, and a second connector. The first connector may be positioned on a first end of the body. The first connector may be removably connectable to the paint sprayer. The second connector may be positioned on a second end of the body. The second end may be opposite the first end. The second connector may be configured for connecting to a water source.

The present embodiment provides, in another aspect, a paint sprayer that may be operable to discharge paint. The paint sprayer may include a frame, a motor assembly, a paint reservoir, a discharge port, and an adapter. The frame may include a trigger. The motor assembly may be supported by the frame. The paint reservoir may be supported by the frame. The discharge port may be fluidly coupled to the paint reservoir. The adapter may be integrally formed in the frame. The adapter may include a connector that may configured for connecting to a water source. Actuation of the trigger may allow water to be discharged from the discharge port.

The present embodiment provides, in a further aspect, a method of using an adapter with a paint sprayer. The method may include aligning a first connecter of the adapter with a connection port of the paint sprayer. The method may also include inserting the first connector into the connection port. The method may also include rotating the adapter relative to the paint sprayer. The method may also include inserting a water source into a second connector. The method may further include actuating a trigger of the paint sprayer.

### BRIEF DESCRIPTION OF THE DRAWINGS

FIG. 1 is a perspective view of a paint sprayer.

FIG. 2 is a perspective view of the paint sprayer of FIG. 1, with a paint reservoir removed.

FIG. 3 is a back perspective view of the paint sprayer of FIG. 1, with a paint reservoir removed.

FIG. 4 is a perspective view of a hose adapter for a paint sprayer according to an embodiment of the invention.

FIG. 5 is a top view of the hose adapter for the paint sprayer of FIG. 4.

FIG. 6 is a side view of the hose adapter for the paint sprayer of FIG. 4.

FIG. 7 is a bottom view of the hose adapter for the paint sprayer of FIG. 4.

FIG. 8 is a front view of the hose adapter for the paint sprayer of FIG. 4.

FIG. 9 is a cross section perspective view of the hose adapter for the paint sprayer of FIG. 4.

FIG. 10 is a front perspective view of a hose adapter for a paint sprayer according to another embodiment of the invention.

FIG. 11 is a back perspective view of the hose adapter for the paint sprayer of FIG. 10.

FIG. 12 is a cross section front view of the hose adapter for the paint sprayer of FIG. 10.

FIG. 13 is a perspective view of a paint sprayer with a hose adapter according to another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

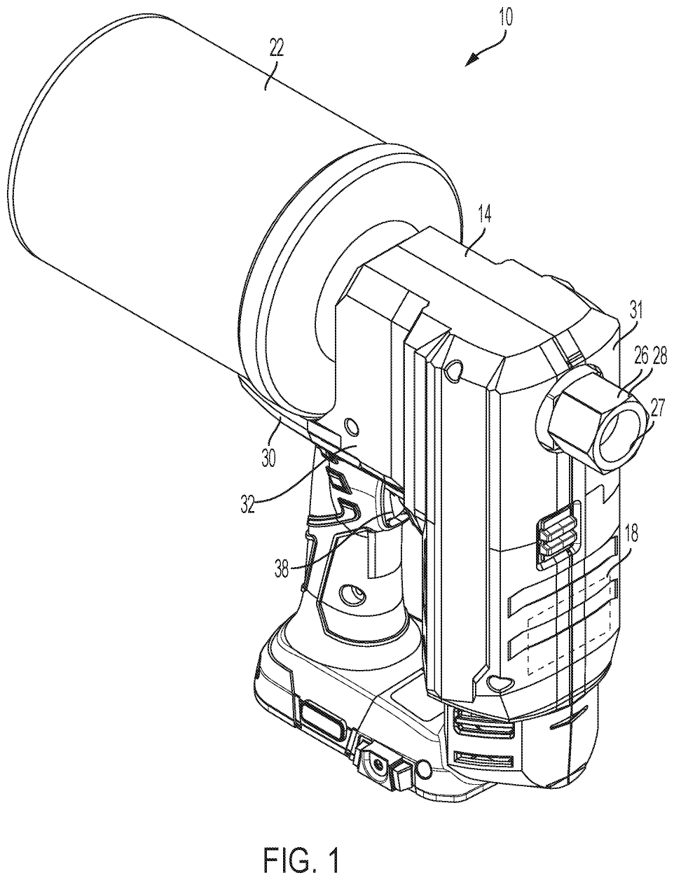

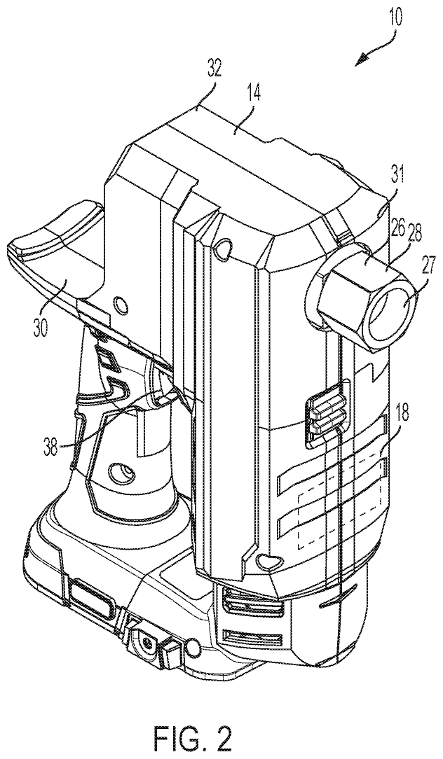

With reference to FIGS. 1-3, a paint sprayer 10 may include a frame 14 and a pump/motor assembly 18 supported by the frame 14. The pump/motor assembly 18 is shown in broken lines in FIGS. 1-2, as it may be internally disposed respective to the frame 14, and may not be visible from outside of the frame 14. The pump/motor assembly 18 may draw paint out of a paint reservoir 22, pressurize the paint, and discharge the pressurized paint toward a discharge port 26, which may have a suitable nozzle tip (not shown) attached thereto. In some embodiments, the paint sprayer 10 may pressurize the paint and discharge the pressurized paint through a mechanical device or assembly (e.g., a hand pump, and/or the like). The discharge port 26 may include an inner surface 27 that may be circular in shape, and an outer surface 28 that may be hexagonal in shape. In other embodiments, the inner surface 27 may be hexagonal, rectangular, or the like, and the outer surface 28 may be circular, rectangular, octagonal, or the like.

Referring to FIG. 2, the frame 14 may include an alcove 30 in which the paint reservoir 22 may be seated. The alcove 30 may be positioned on an opposite side of the frame 14 to that of the discharge port 26. In other words, the discharge port 26 may be positioned on a front end 31 of the frame 14, and the alcove 30 may be positioned on a back end 32 of the frame 14.

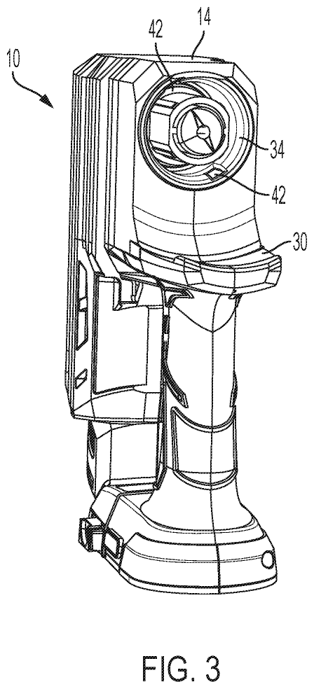

Referring to FIG. 3, the paint reservoir 22 may be removably coupled to the frame 14 via a connection port 34. The connection port 34 may be in fluid communication with the pump/motor assembly 18. The connection port 34 may be positioned on the back end 32 of the frame 14, such that the connection port 34 is positioned proximate to (e.g., above) the alcove 30. When the paint reservoir 22 is seated on the alcove 30, the paint reservoir 22 may be receivable within the connection port 34. An axis of the discharge port 26, which may be created through a center point of the discharge port 26, may be coaxial with an axis created by a center point of the connection port 34. Through actuation of a trigger 38, a pump of the pump/motor assembly 18 begins drawing paint out of the paint reservoir 22, through the discharge port 26 and attached nozzle tip, and onto a working surface.

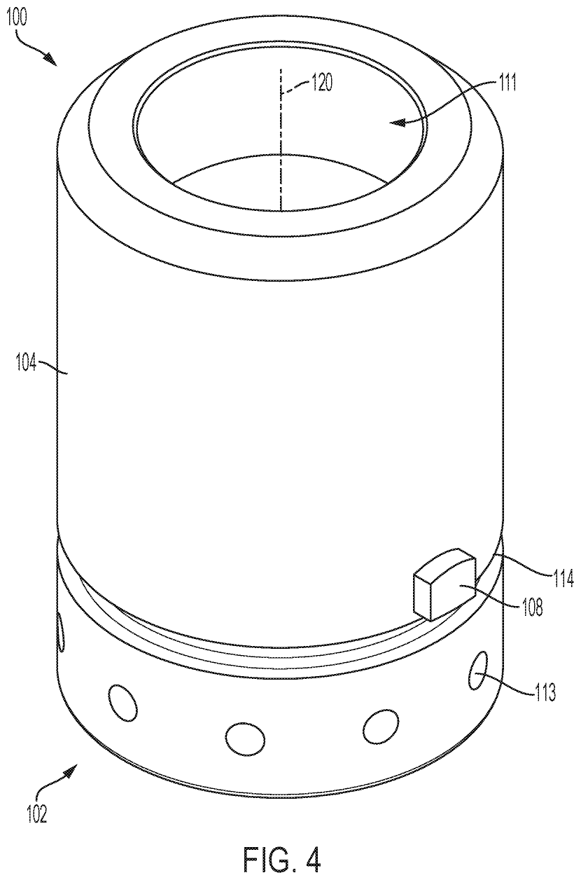

With reference to FIGS. 4-9, an adapter 100 can be coupled to the connection port 34 of the paint sprayer 10 via a first connector or end 102. When the reservoir 22 is removed from the frame 14, the adapter 100 may be coupled to the connection port 34 via the first connector 102. A body 104 of the adapter 100 may include one or more projections 108, which may extend radially outward from the body 104. The projections 108 may be received by one or more recessed portions 42 in the connection port 34 upon and/or through insertion of the first connector 102 into the connection port 34. The adapter 100 may include a second connector or end 111, which may be attached to a hose or other fluid and/or water source (e.g., a garden hose).

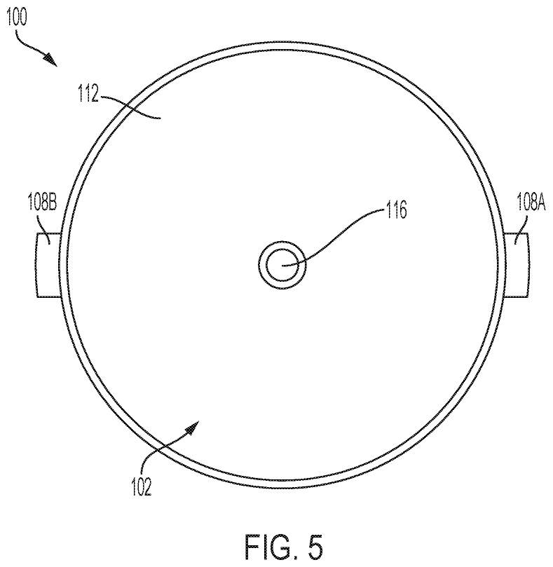

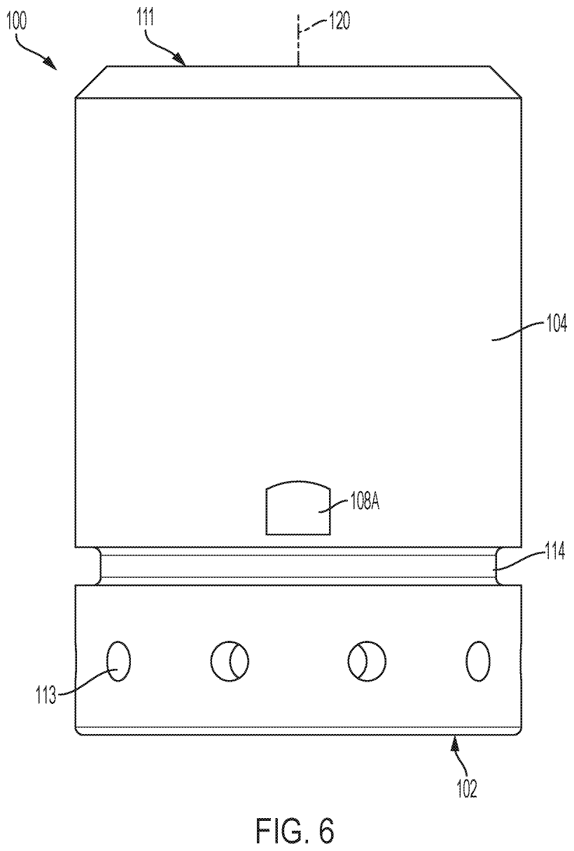

With reference to FIGS. 5 and 6, the first connector 102 may include an end wall 112, one or more apertures 113 which may be formed in and/or positioned proximate to the end wall 112, a recessed groove 114, and the projections 108. The end wall 112, as well as the body 104 of the adapter 100, may be cylindrical in shape. In additional embodiments, the end wall 112 and/or the body 104 may have a cross-sectional shape that is rectangular, hexagonal, and/or the like. A center 116 of the end wall 112 and the body may create an adapter axis 120. The apertures 113 may be positioned above the end wall 112, along the circumference of the body 104. The apertures 113 may be spaced apart at even (e.g., regular) intervals along the circumference of the body 104, although, in some embodiments, the apertures 113 may not be spaced apart at regular intervals. The recessed groove 114 may be positioned above the apertures 113. In other words, a distance between the recessed groove 114 and the end wall 112 may be greater than a distance between the apertures 113 and the end wall 112. The recessed groove 114 may be continuous, or substantially continuous, along the circumference of the body 104, such that an O-ring (not shown) may be positioned within a portion of the recessed groove 114.

In some embodiments, the adapter 100 may include two projections 108 that may be positioned on opposite sides of the body 104. For example, a first projection 108A may extend outwardly from the body 104 in a first direction, and a second projection 108B may extend outwardly from the body 104 in a second direction. The second direction may be opposite that of the first direction. In some embodiments, the adapter 100 may include more than two projections 108. In other embodiments, the projections 108 may not be positioned on opposite sides of the body 104.

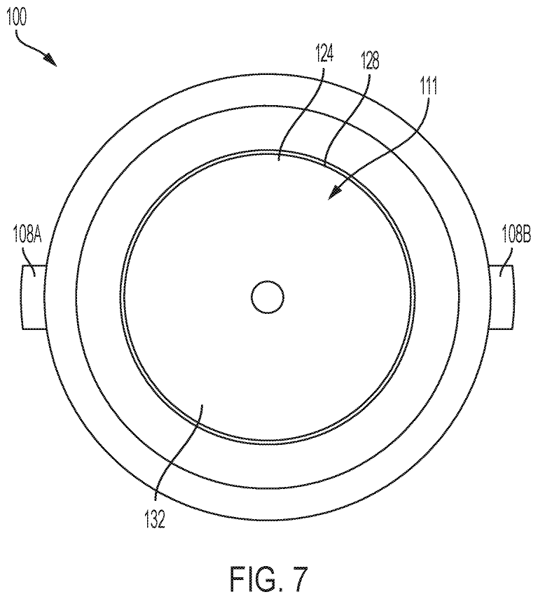

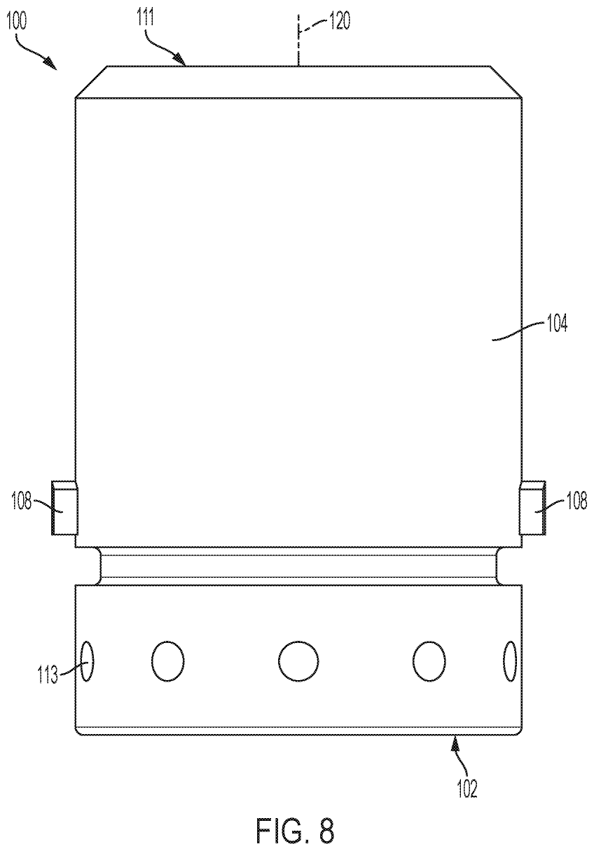

With reference to FIGS. 7 and 8, the second connector 111 may include a hollow portion 124 sized, shaped, and/or generally configured to receive a hose. The hollow portion 124 may be co-axial with the adapter axis 120 and may include a circular cross-sectional shape. In some embodiments, the hollow portion 124 may have a cross-sectional shape that is rectangular, octagonal, non-circular, and/or the like. The hollow portion 124 may include threading (not shown) on a wall 128 of the hollow portion. The threading may allow the hose to be secured to the second connector 111. In other embodiments, the wall 128 may not include threading, with the hose being secured to the adapter 100 by way of alternative methods and/or devices (e.g., fasteners, adhesive, O-ring, etc.). The hollow portion 124 may be formed only partially through the body 104, such that the hollow portion 124 may include a hollow portion end wall 132. The hollow portion end wall 132 may separate the hollow portion 124 from the remainder of the adaptor 100.

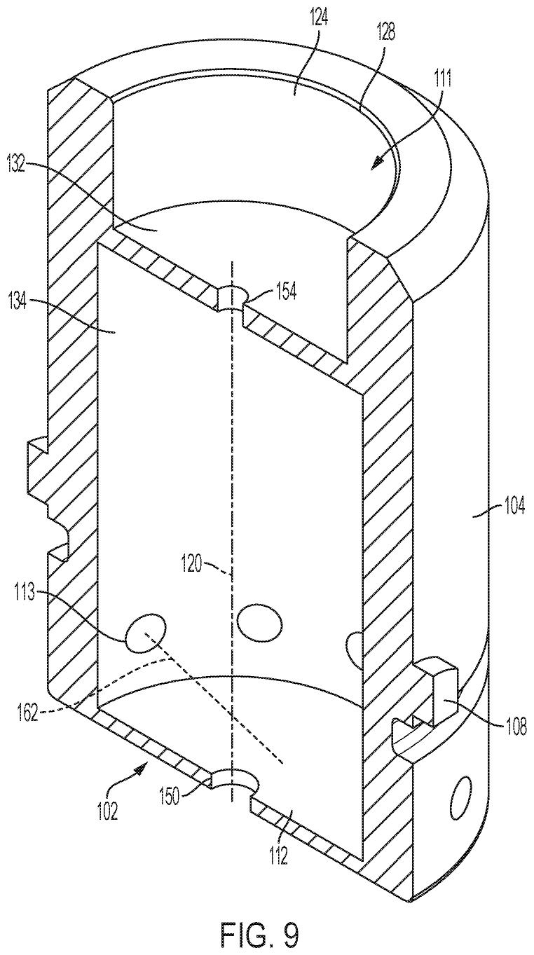

With reference to FIG. 9, the adapter 100 may include a fluid (e.g., water, cleaning solution, and/or the like) reservoir 134 formed by the body 104 of the adapter 100, and in particular the end wall 112 and the hollow portion end wall 132 of the adaptor 100. The end wall 112 may engage with the connection port 34 of the paint sprayer 10. The hollow portion end wall 132 may engage with the hose. A first hole or outlet 150 may be positioned on the adapter axis 120 and may extend through the end wall 112. A second hole or inlet 154 may be positioned on the adapter axis 120 and may extend through the hollow portion end wall 132. In some embodiments, the outlet 150 may have a diameter greater than a diameter of the inlet 154. The holes 150, 154 may allow water to travel through the inlet 154, to the reservoir 134, and through the outlet 150.

The apertures 113 may be in fluid communication with the reservoir 134 and may be positioned at a location between the projections 108 and the end wall 112. The apertures 113 may be positioned such that when the first connector 102 is inserted into the connection port 34, the apertures 113 may be positioned in the connection port 34. Each aperture 113 may have an aperture axis 162 that is perpendicular, or substantially perpendicular, to the adapter axis 120.

To attach the adaptor 100 to the paint sprayer 10, the projections 108 of the adaptor may be aligned with the recessed portions 42 of the paint sprayer 10 and the first connector 102 may be inserted into the connection port 34. Once the projections 108 are received in the recessed portions 42, the adapter 100 may be rotated so the projections 108 are no longer aligned with the recessed portions 42. The projections 108 may be seated in the connection port 34 to lock the projections 108 therein and thereby prevent the adapter 100 from uncoupling from the connection port 34 of the paint sprayer 10. The hose may be attached to the second connector 111, for example, by threadably coupling or insertion. Thereafter, water (e.g., or other fluid) may be supplied to the hose. The water may travel through the inlet 154 of the adapter 100, through the reservoir 134, and out of the adapter 100 through the outlet 150. When the trigger 38 is actuated on the paint sprayer 10, the water may travel through the outlet 150 and into the paint sprayer 10 to flush the components of the paint sprayer 10. Water may exit the paint sprayer 10 through the discharge port 26 and nozzle tip (if attached). The water may flush the paint sprayer 10, which may clean out paint stuck on internal components of the paint sprayer 10. In this way, the paint sprayer 10 may be more easily and/or efficiently cleaned after use.

To remove the adaptor 100 from the paint sprayer 10, the adaptor 100 may be rotated until the projections 108 align with the recessed portions 42. The adaptor 100 may then be removed from the connection port 34.

The adaptor 100 may also be used to facilitate cleaning of the paint reservoir 22. In this operation, a hose may be attached to the second connector 111 of the adapter 100. Additionally, the first connector 102 of the adapter 100 may be attached to the paint reservoir 22. When water (e.g., or other fluid) is supplied to the hose, the apertures 113 may allow water to flow through the apertures 113 and through the outlet 150 into the reservoir 22. This operation may clean the interior cavity of the reservoir 22. The adapter 100 may then be removed from the reservoir 22, and the water and debris still in the reservoir 22 may then be emptied from the paint reservoir 22.

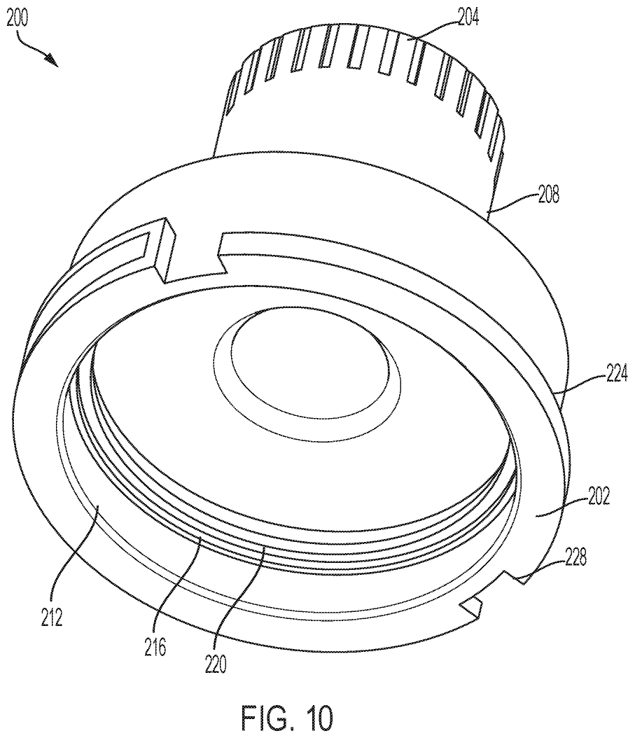

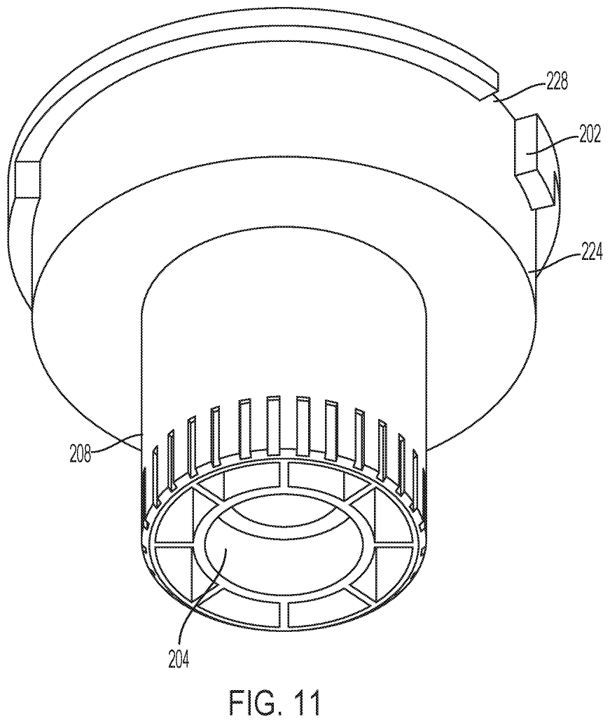

FIGS. 10-12 illustrate an adapter 200 according to another embodiment of the invention. The adapter 200 of FIG. 10 is similar to the adapter 100 of FIG. 4. As such, only differences between the adapter 200 of FIG. 10 and the adapter 100 of FIG. 4 will be explained in detail. Similar to the adapter 100 of FIG. 4, the adapter 200 includes a first connector 202 that may be coupled to the connection port 34 of the paint sprayer 10 and a second connector 204 which may be attached to the hose or other fluid and/or water source.

With reference to FIG. 10, the first connector 202 differs from the first connector 102 in that the first connector 202 may be defined by a diameter that may be larger than a diameter of a body 208 of the adapter 200. Additionally, the first connector 202 may include a recessed area 212 that may receive a portion of the connection port 34. The recessed area 212 may include ridges 216 formed at an end 220 of the recessed area 212, which may secure the adapter 200 to the connection port 34. The first connector 202 may further include an outer surface 224 with a connection interface 228. The connection interface 228 may receive protrusions (not shown) formed in the connection port 34. After the connection interface 228 has received the protrusions, the adapter 200 may be rotated relative to the connection port 34. This interaction may prevent axial motion of the adapter 200 relative to the connection port 34. The ridges 216 of first connector 202 may prevent unintentional rotation of the adapter 200 relative to the connection port 34 of the paint sprayer 10, which may prevent the protrusions from disengaging with the connection interface 228 without a user input force.

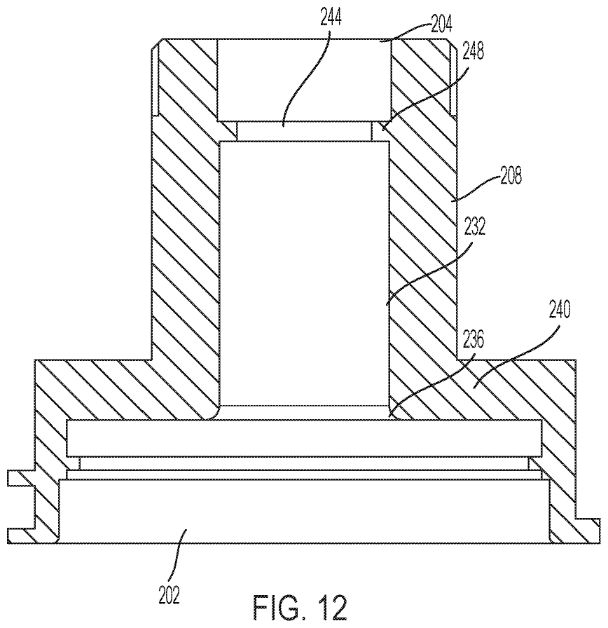

With reference to FIG. 12, the body 208 is similar to the body 104 of the adapter 100 in that the body 208 forms a reservoir 232. The reservoir 232 may include an outlet 236 formed on an end wall 240 of the first connector 202 and an inlet 244 formed on a hollow portion end wall 248 of the second connector 204. The outlet 236 may form a diameter that may be larger than a diameter of the reservoir 232. The inlet 244 may form a diameter that is smaller than a diameter of the reservoir 232. The inlet 244 and the outlet 236 may allow water to travel through the inlet 244, to the reservoir 232, and through the outlet 236.

In use, the first connector 202 may receive the protrusions of the connection port 34. The adapter 200 may then be rotated relative to the paint sprayer 10, which may secure the adapter 200 to the paint sprayer 10. Thereafter, the second connector 204 of the adapter 200 may be attached to the hose. The water may be supplied to the inlet 244 via the hose. The water may then travel into the inlet 244, to the reservoir 232, and out the outlet 236 of the adapter 200. When the trigger 38 of the paint sprayer 10 is actuated, the water may travel through the outlet 236 and into the paint sprayer 10 to flush the components of the paint sprayer 10.

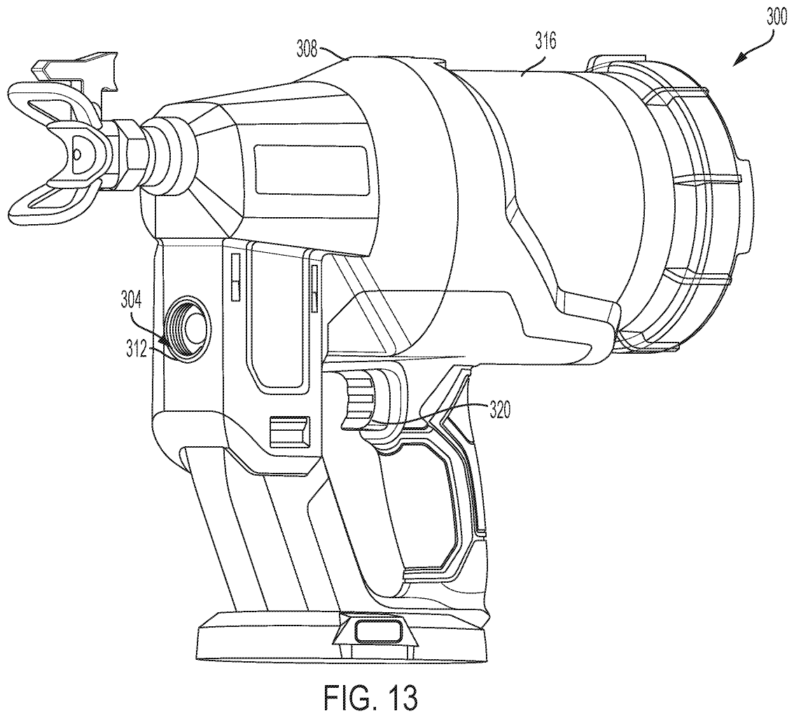

FIG. 13 illustrates a paint sprayer 300 according to another embodiment of the invention. The paint sprayer 300 of FIG. 13 is similar to the paint sprayer 10 of FIG. 1. As such, only differences between the paint sprayer 300 of FIG. 13 and the paint sprayer 10 of FIG. 1 will be explained in detail. The paint sprayer 300 differs from the paint sprayer 10 in that the paint sprayer 300 may integrate an adapter 304 within a housing 308 of the paint sprayer 300. The adapter 304 may be substantially the same as the adapter 100. In other embodiments, the adapter 304 may be substantially the same as the adapter 200. A second connector 312 may be the only portion externally visible. The second connector 312 may allow a hose to be coupled directly to the paint sprayer 300. Since the adapter 304 is integrally formed in the housing 308 of the paint sprayer 300, a paint reservoir 316 may not need to be removed.

In operation, the hose may be secured to the second connector 312. Thereafter, water may be supplied to the hose. Water may travel through an inlet of the adapter 304, through a water reservoir, and to an outlet. When a trigger 320 is actuated on the paint sprayer 300, the water may flow through the outlet and into the paint sprayer 300 to flush the components of the paint sprayer 300. Water may exit the paint sprayer 300 through a discharge port 324 and a nozzle tip. The water may flush the paint sprayer 300, which may clean out paint stuck on internal components of the paint sprayer 300.

Although the invention has been described in detail with reference to certain preferred embodiments, variations and modifications exist within the scope of one or more independent aspects of the invention as described.

What is claimed is:

1. An adapter connectable to a paint sprayer, the adapter comprising:
a body;
a first connector positioned on a first end of the body, wherein the first connector is removably connectable to the paint sprayer; and
a second connector positioned on a second end of the body, the second end being opposite the first end, wherein the second connector is configured for connecting to a fluid source.

2. The adapter of claim 1, wherein the first connector includes a projection, and wherein the projection is configured to secure the adapter to the paint sprayer.

3. The adapter of claim 2, wherein the projection is configured to engage a recess of the paint sprayer.

4. The adapter of claim 1, wherein the second connector threadably engages with the fluid source.

5. The adapter of claim 1, wherein the fluid source is a hose.

6. The adapter of claim 1, wherein the body is cylindrical in shape.

7. The adapter of claim 1, wherein the body includes one or more apertures disposed on the body, and wherein the one or more apertures are fluidly coupled to the fluid source.

8. The adapter of claim 1, wherein a recess is formed on the body, the recess being sized to receive an O-ring.

9. A paint sprayer operable to discharge paint, the paint sprayer comprising:
a frame including a trigger;
a motor assembly supported by the frame;
a paint reservoir supported by the frame;
a discharge port fluidly coupled to the paint reservoir; and
an adapter integrally formed with the frame, the adapter including a connector configured for connecting to a fluid source;
wherein actuation of the trigger allows a fluid to be discharged from the discharge port.

10. The paint sprayer of claim 9, wherein the connector of the adapter is threaded, and wherein the fluid source is threadably engageable with the connector.

11. The paint sprayer of claim 9, wherein the fluid source is a hose.

12. The paint sprayer of claim 9, wherein the connector is the only visible component of the adapter.

13. The paint sprayer of claim 9, wherein the discharge port includes a nozzle tip.

14. A method, the method comprising:
aligning a first connector of an adapter with a connection port of a paint sprayer;
inserting the first connector into a portion of the connection port;
rotating the adapter relative to the paint sprayer for securing the adapter to the paint sprayer;
attaching a fluid source to a second connector of the adapter; and
causing a fluid to flow from the fluid source through the second connector and into the paint sprayer for cleaning a portion of the paint sprayer.

15. The method of claim 14, further comprising aligning a projection of the first connector with a recession of the connection port.

16. The method of claim 15, wherein the first connector includes at least two projections and the connection portion includes at least two recessions.

17. The method of claim 14, wherein the fluid comprises water or a cleaning solution.

18. The method of claim 14, further comprising removing the adapter from the paint sprayer.

19. The method of claim 18, further comprising inserting a paint container into the portion of the connection port.

20. The method of claim 14, wherein the fluid source is a hose.
